(19) United States
(12) Patent Application Publication
(10) Pub. No.: US 2026/0252879 A1
(43) Pub. Date: Aug. 27, 2026

(54) SENTENCE GENERATION DEVICE, SENTENCE GENERATION METHOD, AND NON-TRANSITORY COMPUTER-READABLE MEDIUM

(71) Applicant: NEC Corporation, Tokyo (JP)

(72) Inventors: Kosuke AKIMOTO, Tokyo (JP); Kunihiro TAKEOKA, Tokyo (JP); Masafumi ENOMOTO, Tokyo (JP); Masafumi OYAMADA, Tokyo (JP); Ryoma ISHIGAKI, Tokyo (JP)

(73) Assignee: NEC Corporation, Tokyo (JP)

(21) Appl. No.: 19/539,957

(22) Filed: Feb. 13, 2026

(30) Foreign Application Priority Data
Feb. 25, 2025 (JP) 2025-028232

(51) Int. Cl. G06N 3/08; G06F 16/951; G06F 40/56

(52) U.S. Cl. CPC G06N 3/08; G06F 16/951; G06F 40/56

(57) ABSTRACT

A sentence generation device capable of generating a sentence in which information elements are included in a desired distribution is implemented. The sentence generation device that generates a sentence composed of a natural language sentence includes an information element distribution requirement acquisition unit that acquires an information element distribution requirement regarding a distribution of the information elements to be included in the sentence, and a sentence generation unit that generates the sentence so as to satisfy the information element distribution requirement using a language model. The generated sentences can also be utilized as training data for AI systems to facilitate automated decision making in diverse machine-learning scenarios.

### INCORPORATION BY REFERENCE

This application is based upon and claims the benefit of priority from Japanese patent application No. 2025-028232, filed on Feb. 25, 2025, the disclosure of which is incorporated herein in its entirety by reference.

### TECHNICAL FIELD

The present disclosure relates to a sentence generation device, a sentence generation method, and a sentence generation program.

### BACKGROUND ART

Laban, Philippe, et al. “Summary of a Haystack: A Challenge to Long-Context LLMs and RAG Systems.” arXiv preprint arXiv: 2407.01370 (2024) describes a technique of creating a plurality of subtopics to be included in a sentence, generating an information element for each subtopic, and generating a sentence including the generated information element by a language model.

### SUMMARY

In the technique described in Laban, Philippe, et al. “Summary of a Haystack: A Challenge to Long-Context LLMs and RAG Systems.” arXiv preprint arXiv: 2407.01370 (2024), since a sentence is generated by randomly sampling the generated information elements, it is not possible to control the distribution of the information elements in the generated sentence. Here, it is known that the sentence processing capability of the language model is affected by the distribution of the information elements in the sentence to be processed. Therefore, it is required to generate a sentence in which information elements are included in a desired distribution.

The present disclosure has been made in view of the above problems, and an example object thereof is to provide a technique for generating a sentence in which information elements are included in a desired distribution.

A sentence generation device according to an example aspect of the present disclosure is a sentence generation device that generates a sentence composed of a natural language sentence, the sentence generation device including an information element distribution requirement acquisition unit that acquires an information element distribution requirement regarding a distribution of the information elements to be included in the sentence, and a sentence generation unit that generates the sentence so as to satisfy the information element distribution requirement using a language model.

A sentence generation method according to an example aspect of the present disclosure is a sentence generation method in which at least one processor generates a sentence composed of a natural language sentence, the method including information element distribution requirement acquisition processing of acquiring, by the at least one processor, an information element distribution requirement regarding a distribution of information elements to be included in the sentence, and sentence generation processing of generating, by the at least one processor, the sentence so as to satisfy the information element distribution requirement using a language model.

A sentence generation program according to an example aspect of the present disclosure causes a sentence generation program for causing a computer to function as a sentence generation device that generates a sentence composed of a natural language sentence, the program for causing the computer to execute an information element distribution requirement acquisition unit that acquires an information element distribution requirement regarding a distribution of information elements to be included in the sentence, and a sentence generation unit that generates the sentence so as to satisfy the information element distribution requirement using a language model.

According to an example aspect of the present disclosure, an example advantage achieved is that it is possible to provide a technique for generating a sentence in which information elements are included in a desired distribution.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a sentence generation device according to the present disclosure;

FIG. 2 is a flowchart illustrating a flow of a sentence generation method according to the present disclosure;

FIG. 3 is a block diagram illustrating a configuration of a sentence generation system according to the present disclosure;

FIG. 4 is a diagram schematically illustrating an example of an information element distribution requirement according to the present disclosure;

FIG. 5 is a flowchart illustrating a flow of a sentence generation method according to the present disclosure;

FIG. 6 is a diagram schematically illustrating a specific example of information generated by the sentence generation method according to the present disclosure;

FIG. 7 is a block diagram illustrating a configuration of a sentence generation system according to the present disclosure;

FIG. 8 is a flowchart illustrating a flow of an evaluation method by the sentence generation device according to the present disclosure; and

FIG. 9 is a block diagram illustrating a hardware configuration of a computer that functions as each of the above devices according to the present disclosure.

### EXAMPLE EMBODIMENTS

Hereinafter, example embodiments will be exemplified. However, the present disclosure is not limited to the following illustrative example embodiments, and various modifications may be made within the scope described in the claims. For example, the following example embodiments obtained by appropriately combining techniques (some or all of objects or methods) adopted in the illustrative example embodiments may also fall within the scope of the present disclosure. Example embodiments obtained by appropriately omitting some of the techniques adopted in the following illustrative example embodiments may also fall within the scope of the present disclosure. Effects mentioned in the following illustrative example embodiments are examples of effects expected in the illustrative example embodiments, and do not define extension of the present disclosure. That is, example embodiments that do not exert the effects mentioned in the following illustrative example embodiments may also fall within the scope of the present disclosure.

### First Illustrative Example Embodiment

A first illustrative example embodiment, which is an example of an example embodiment, will be described in detail with reference to the drawings. The present illustrative example embodiment is a basic form of each illustrative example embodiment described below. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in the drawings referred to for describing the present illustrative example embodiment can also be adopted in another illustrative example embodiment included in the present disclosure within a range in which no particular technical problem occurs.

### Configuration of Sentence Generation Device

A sentence generation device 1 is a device that generates a sentence composed of a natural language sentence. The “sentence” is a character string described in a natural language sentence, and includes, for example, a plurality of partial sentences (hereinafter, described as a partial sentence). The sentence generation device 1 can be used for an application of generating a natural long sentence.

A configuration of the sentence generation device 1 will be described with reference to FIG. 1. FIG. 1 is a block diagram illustrating a configuration of the sentence generation device 1. As illustrated in FIG. 1, the sentence generation device 1 includes an information element distribution requirement acquisition unit 11 and a sentence generation unit 12. The information element distribution requirement acquisition unit 11 is an example of a configuration that implements an information element distribution requirement acquisition means. The sentence generation unit 12 is an example of a configuration for implementing a sentence generation means.

The information element distribution requirement acquisition unit 11 acquires the information element distribution requirement regarding the distribution of the information elements to be included in the sentence. The “information element” is information described in a partial sentence (phrases, sentences, paragraphs, etc.) forming (i.e., constituting) a sentence to be generated with a certain degree of unity. For example, the information element may conceptually indicate the partial sentence, may not be the character string itself of the partial sentence, or may be the character string itself.

For example, a first partial sentence “Sales of company A were 3 trillion yen in 2023.” described in a part of a certain sentence includes “information element regarding the sales of company A”. For example, a second partial sentence “(Reference) Sales in 2022 were 2.9 trillion yen.” described in another part of the same certain sentence also includes the “information element regarding the sales of company A”. That is, the first partial sentence and the second partial sentence include the same information element although the first partial sentence and the second partial sentence are different from each other as character strings.

The “information element distribution requirement” indicates a constraint on the distribution of the information elements in the sentence. For example, the information element distribution requirement may be a constraint on which information element should be included in which arrangement or length in the sentence to be generated. The information element distribution requirement may be expressed by a natural language sentence. Examples of the information element distribution requirement include “information related to the topic X is described separately in five places” and “three pieces of information that are not related to the topic X and have similarity such as sharing a proper noun with information related to the topic X are included”. However, the information element distribution requirement is not limited thereto.

The sentence generation unit 12 generates a sentence so as to satisfy the information element distribution requirement using the language model. For example, the sentence generation unit 12 may generate a sentence by inputting, to the language model, an instruction sentence to generate a sentence that satisfies the information element distribution requirement.

The sentence generation unit 12 may generate an information element so as to satisfy the information element distribution requirement, and generate a sentence using the generated information element. For example, the sentence generation unit 12 may generate a plurality of information elements by a language model based on the information element distribution requirement. The sentence generation unit 12 may generate a partial sentence relevant to each information element by a language model, and generate a sentence by combining the generated partial sentences based on the information element distribution requirement.

### Effects of Sentence Generation Device

As described above, the sentence generation device 1 that generates a sentence composed of a natural language sentence includes the information element distribution requirement acquisition unit 11 that acquires the information element distribution requirement regarding the distribution of the information elements to be included in the sentence, and the sentence generation unit 12 that generates the sentence so as to satisfy the information element distribution requirement using the language model. Therefore, according to the sentence generation device 1, it is possible to generate a sentence including a desired information element in a desired distribution.

### Flow of Sentence Generation Method S1

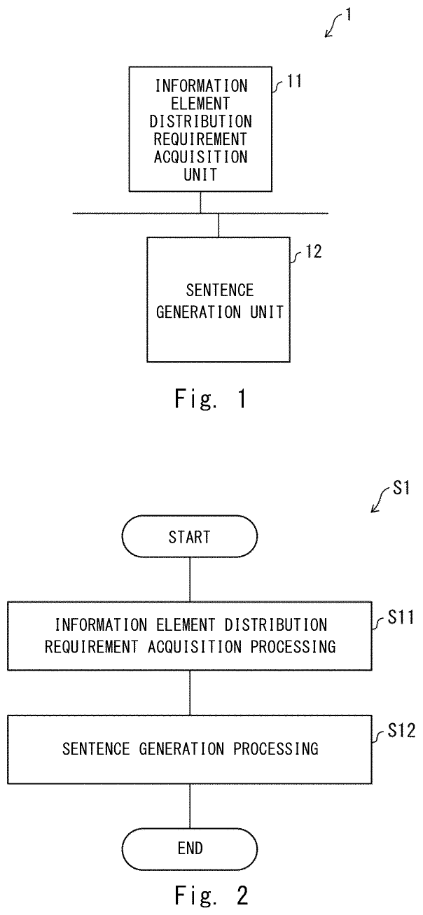

A flow of a sentence generation method S1 will be described with reference to FIG. 2. The sentence generation method S1 is a method in which at least one processor generates a sentence composed of a natural language sentence. For example, in a case where the sentence generation device 1 includes at least one processor, the sentence generation device 1 executes the sentence generation method S1. FIG. 2 is a flowchart illustrating a flow of the sentence generation method S1. As illustrated in FIG. 2, the sentence generation method S1 includes information element distribution requirement acquisition processing S11 and sentence generation processing S12.

In the information element distribution requirement acquisition processing S11, at least one processor (for example, the information element distribution requirement acquisition unit 11) acquires the information element distribution requirement regarding the distribution of the information elements to be included in the sentence. Details of the information element distribution requirement acquisition processing S11 will be described similarly to the information element distribution requirement acquisition unit 11, and thus detailed description will not be repeated.

In the sentence generation processing S12, at least one processor (for example, the sentence generation unit 12) generates a sentence so as to satisfy the information element distribution requirement using the language model. Details of the sentence generation processing S12 are described similarly to the sentence generation unit 12, and thus detailed description will not be repeated.

### Effect of Sentence Generation Method S1

As described above, in the sentence generation method S1, a method is adopted in which at least one processor generates a sentence composed of a natural language sentence, the method including the information element distribution requirement acquisition processing S11 in which the at least one processor acquires the information element distribution requirement regarding the distribution of the information elements to be included in the sentence, and the sentence generation processing S12 in which the at least one processor generates a sentence so as to satisfy the information element distribution requirement using the language model. Therefore, according to the sentence generation method S1, the same effects as those of the sentence generation device 1 can be obtained.

### Second Illustrative Example Embodiment

A second illustrative example embodiment, which is an example of an example embodiment, will be described in detail with reference to the drawings. Constituents having the same functions as the constituents described in the above-described illustrative example embodiment are denoted by the same reference sign, and the description thereof will be omitted as appropriate. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be employed in the other illustrative example embodiments included in the present disclosure within the scope in which no particular technical problem occurs.

### Outline of Sentence Generation System 100a

A sentence generation system 100A is a system that generates a query and a sentence to be input to a language model. For example, the query and the sentence generated by the sentence generation system 100A may be used to evaluate the sentence processing capability of the language model.

### Configuration of Sentence Generation System 100A

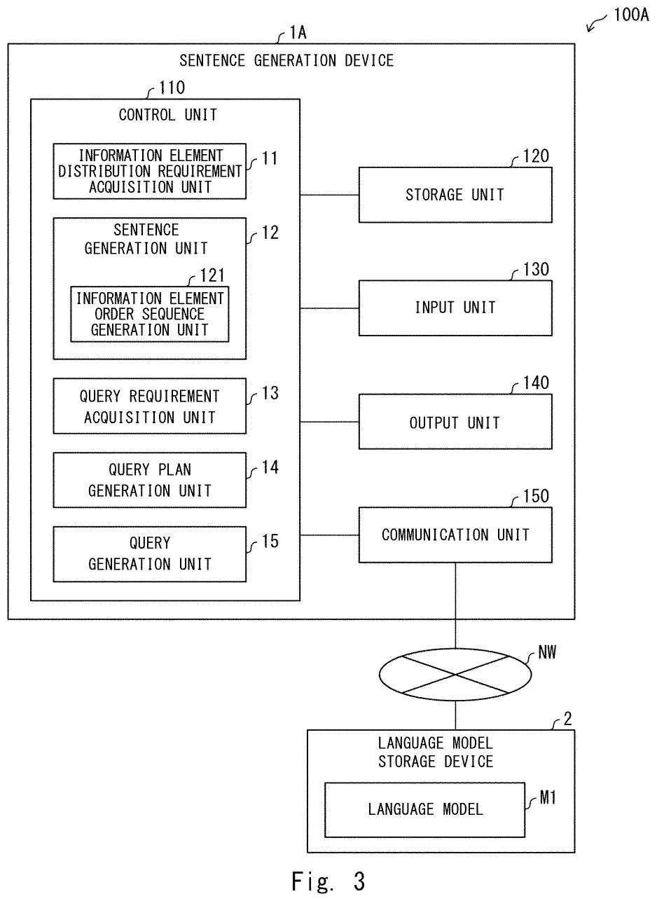

A configuration of the sentence generation system 100A will be described with reference to FIG. 3. FIG. 3 is a block diagram illustrating a configuration of the sentence generation system 100A. The sentence generation system 100A includes a sentence generation device 1A and a language model storage device 2. The sentence generation device 1A and the language model storage device 2 are communicably connected via a network NW. The network NW may include a wireless local area network (LAN), a wired LAN, a wide area network (WAN), a public network, a mobile data communication network, or a combination of some or all of the networks but is not limited thereto. However, the network NW is not limited to the above-described example.

### Language Model Storage Device 2

The language model storage device 2 stores a language model M1. The language model M1 is a model that generates a sentence relevant to an instruction sentence. Examples of the language model M1 include, but are not limited to, a model called a large language model meta AI (LLaAM) and other large language models. The language model M1 is used in a process in which the sentence generation device 1A generates a query and a sentence. The language model used in the process of generating the query and the sentence by the sentence generation device 1A is not limited to one, and may be plural. For example, another language model different from the language model M1 may be further stored in the language model storage device 2. Another language model storage device that stores another language model may be communicably connected to the sentence generation device 1A. In this case, the “language model M1” in the following description may be replaced with “any language model selected from the language model M1 and other language models”. The language model storage device 2 may be included in the sentence generation device 1A instead of being connected to the sentence generation device 1A.

### Sentence Generation Device 1a

The sentence generation device 1A includes a control unit 110, a storage unit 120, an input unit 130, an output unit 140, and a communication unit 150.

### Communication Unit 150

The communication unit 150 communicates with a device outside the sentence generation device 1A. As an example, the communication unit 150 communicates with the language model storage device 2. The communication unit 150 transmits data supplied from the control unit 110 to an external device and supplies data received from the external device to the control unit 110. The data transmitted by the communication unit 150 to the language model storage device 2 can include various types of instruction sentences to be input to the language model M1. The data received by the communication unit 150 from the language model storage device 2 can include a sentence output from the language model M1 in response to the input of the instruction sentence.

### Input Unit 130 and Output Unit 140

The input unit 130 includes an input device such as a keyboard, a mouse, or a microphone. The output unit 140 includes an output device of at least any one of a display and a speaker. The input unit 130 and the output unit 140 may include an input/output device integrally formed as a touch panel or the like. One or both of the input unit 130 and the output unit 140 may be connected to the sentence generation device 1A instead of being built in the sentence generation device 1A, or may be built in or connected to a terminal (not illustrated) communicably connected to the sentence generation device 1A.

### Storage Unit 120

The storage unit 120 stores various items of data to be referred to by the control unit 110 and various items of data generated by the control unit 110. As an example, the storage unit 120 stores an information element distribution requirement, a query requirement, an information element, an order sequence, a partial sentence, and the like. Details of these pieces of information will be described later.

### Control Unit 110

The control unit 110 integrally controls each unit of the sentence generation device 1A. For example, the control unit 110 includes a query requirement acquisition unit 13, a query plan generation unit 14, and a query generation unit 15 in addition to the information element distribution requirement acquisition unit 11 and the sentence generation unit 12 included in the sentence generation device 1. The query requirement acquisition unit 13 is an example of a configuration that implements a query requirement acquisition means. The query generation unit 15 is an example of a configuration for implementing a query generation means.

The query requirement acquisition unit 13 acquires the query requirement regarding the query indicating the natural language processing task to be performed on the generated sentence. For example, the query requirement may be described in a natural language sentence. The query is information indicating the natural language processing task content for the target sentence. Examples of the query include natural language sentences such as “Summarize given medical conversation” and “Answer questions about an academic paper in a given natural language processing field”.

The query requirement is a requirement regarding the content of the natural language processing task for the sentence to be generated. The query requirement includes a requirement regarding a type (for example, types such as “summary processing”, “question answer processing”, and “editing processing”) of the natural language processing task. The query requirement may include a requirement regarding the content or type (for example, “medical dialogue”, “news article”, “academic paper”, etc.) of the sentence to be processed. The query requirement may include a requirement (for example, “reference to a plurality of information elements is necessary for an answer” or the like) regarding execution of the natural language processing task. However, the query requirement may be any requirement regarding the query, and is not limited to the above-described example.

The query plan generation unit 14 generates a query plan based on the query requirement. The “query plan” is information indicating what kind of information is required in the sentence to be generated. As an example of the query plan, there is information indicating a specific content of a sentence or a content of a natural language processing task such as “Exhaustively list proponent and opponent arguments based on proponent Bob's and opponent Jessica's arguments on generic drugs”. Another example of the query plan includes information indicating a topic such as simply “chat in medical field”. The query plan may be the query itself. For example, the query plan generation unit 14 may generate the query plan by inputting, to the language model M1, an instruction sentence to generate the query plan that satisfies the query requirement.

The information element distribution requirement acquisition unit 11 is configured in the same manner as in the first example embodiment, and in addition, the information element distribution requirement to be acquired is configured as follows. The information element distribution requirement includes a requirement regarding an information element related to a query or a requirement regarding an information element not related to a query. The information element distribution requirement includes a requirement regarding a feature of an order sequence of the information element and a requirement regarding a feature unique to the information element.

Here, the features of the order sequence of the information element include, for example, diffusion, similarity, and repeat. Diffusion represents a feature of how many different positions in a sentence an information element of a certain concept is divided and described. Similarity represents a feature that an information element of a certain concept is similar to other information elements. Repeat represents a feature of the number of times an information element of the same concept appears redundantly in a sentence.

The feature unique to the information element includes, for example, a scope. The scope represents a feature of how long a certain information element is described in a sentence. Features unique to an information element may vary among a plurality of information elements.

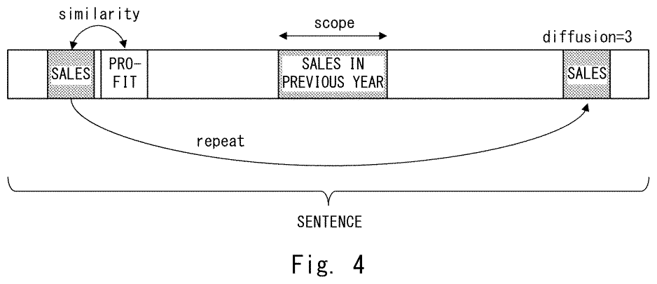

FIG. 4 is a diagram schematically illustrating an example of an information element distribution requirement. The sentence illustrated in FIG. 4 includes an information element a1 regarding sales, an information element a2 regarding a profit, an information element a3 regarding sales in the previous year, and an information element a4 regarding sales in this order. For example, in a case where the query is “How did sales of company A in 2023 change from last year?”, the information elements a1, a3, and a4 related to sales are information elements related to the query. The information element a2 related to the profit is an information element not related to the query.

For example, “scope” illustrated in FIG. 4 represents how long the information element a3 is described in the sentence (in other words, the length of the partial sentence relevant to the information element a3). “Diffusion” illustrated in FIG. 4 indicates that the information elements a1, a3, and a4 related to the query are described separately at three different positions in the sentence. “Similarity” illustrated in FIG. 4 indicates a degree of similarity between the information element a1 related to the query and the information element a2 not related to the query. “Repeat” illustrated in FIG. 4 represents the number of times “2” that the information elements a1 and a4 related to “sales” appear redundantly in the sentence.

The sentence generation unit 12 is configured as follows in addition to being configured similar to that in the first example embodiment. The sentence generation unit 12 further refers to the query requirement and generates a sentence satisfying the information element distribution requirement. For example, the sentence generation unit 12 may generate a sentence that satisfies the information element distribution requirement by further referring to the query plan generated based on the query requirement. For example, it is assumed that the information element distribution requirement includes a requirement regarding distribution of information elements related to (or not related to) a query. In this case, in order to generate a sentence satisfying the information element distribution requirement, it is necessary to refer to the query requirement (or the query plan).

The sentence generation unit 12 includes an information element order sequence generation unit 121 that generates an order sequence of information elements based on a requirement regarding a feature as an order sequence of information elements. The sentence generation unit 12 generates a sentence based on the requirement regarding the features unique to the order sequence and the information element. For example, the information element order sequence generation unit 121 may generate each of the plurality of information elements to be included in the sentence by inputting, to the language model M1, an instruction sentence to generate the information element satisfying the information element distribution requirement. The information element order sequence generation unit 121 may generate an order sequence in which a plurality of generated information elements are arranged so as to satisfy the information element distribution requirement. The sentence generation unit 12 may generate a partial sentence by inputting, to the language model M1, an instruction sentence to generate a partial sentence relevant to each information element so as to satisfy a feature unique to the information element. For example, the sentence generation unit 12 may generate the sentence by combining the partial sentences relevant to the information elements generated in this way according to the order sequence.

The query generation unit 15 generates a query with reference to the sentence generated by the sentence generation unit 12 and the query requirement. For example, the query generation unit 15 may generate a query with reference to the sentence generated by the sentence generation unit 12 and the query plan generated based on the query requirement. For example, the query generation unit 15 may generate a query by inputting, to the language model M1, an instruction sentence to generate an executable query for the generated sentence based on the query plan.

### Flow of Sentence Generation Method S1a

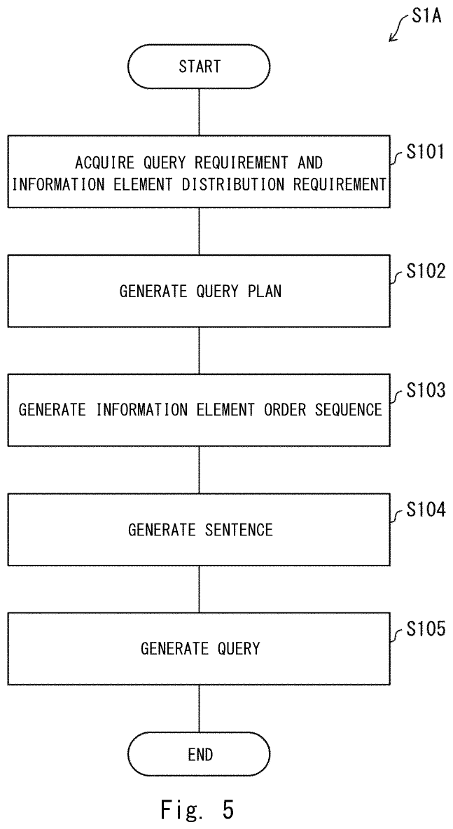

The sentence generation system 100A configured as described above executes a sentence generation method S1A. FIG. 5 is a flowchart illustrating a flow of the sentence generation method S1A. As illustrated in FIG. 5, the sentence generation method S1A includes steps S101 to S105.

In step S101, the query requirement acquisition unit 13 acquires the query requirement. The information element distribution requirement acquisition unit 11 acquires the information element distribution requirement. For example, information input by the user via the input unit 130 may be acquired as one or both of the query requirement and the information element distribution requirement. Information stored in advance in the storage unit 120 may be acquired as one or both of the query requirement and the information element distribution requirement.

In step S102, the query plan generation unit 14 generates a query plan based on the query requirement using the language model M1.

In step S103, the information element order sequence generation unit 121 generates a plurality of information elements using the language model M1 so as to satisfy the requirement regarding the features of the order sequence of the information elements. The information element order sequence generation unit 121 generates an order sequence of the plurality of generated information elements so as to satisfy a requirement regarding a feature of the order sequence of the information elements.

In step S104, the sentence generation unit 12 generates a partial sentence relevant to each information element using the language model M1 so as to satisfy the requirement regarding the characteristic unique to each information element. The sentence generation unit 12 generates a sentence by combining the generated partial sentences according to the order sequence.

In step S105, the query generation unit 15 generates a query using the language model M1 based on the generated sentences and the query plan. The generated sentence and query are output to the output unit 140. Thus, the sentence generation method S1A ends.

### Specific Example

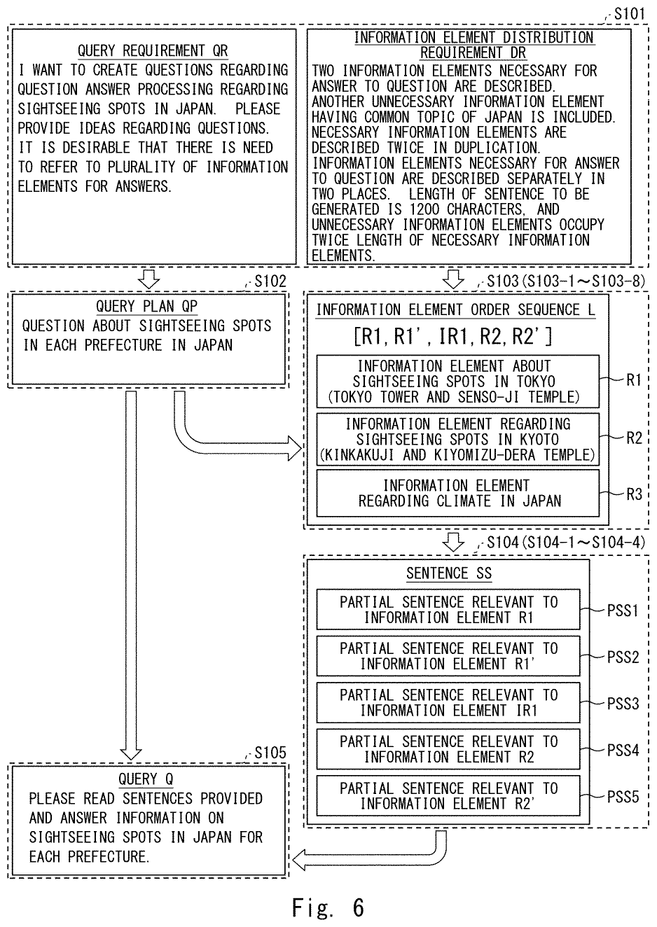

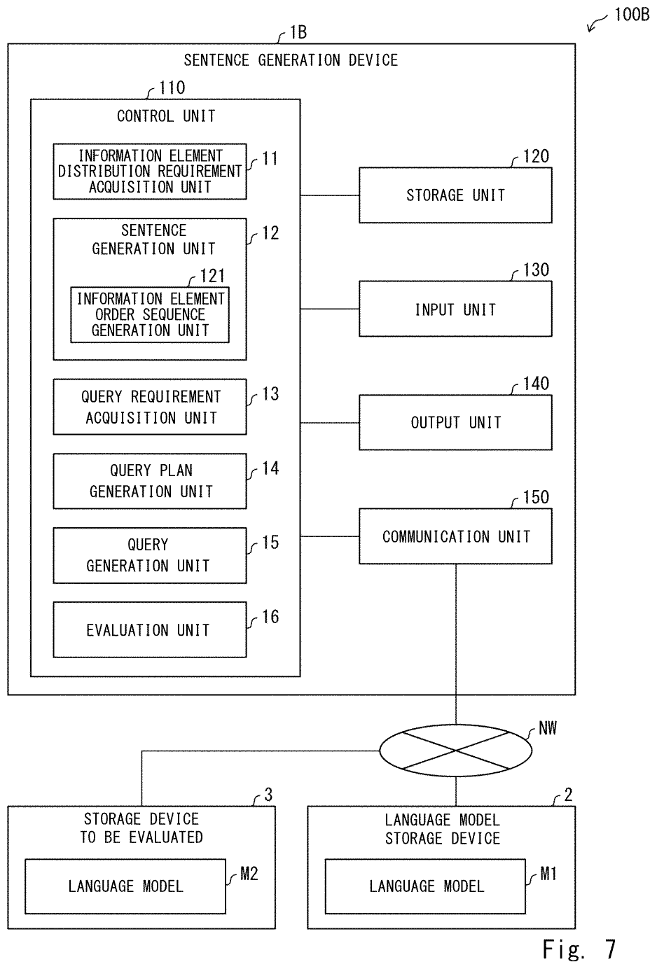

FIG. 6 is a diagram schematically illustrating a specific example of information generated by the sentence generation method S1A.

### Specific Example of Step S101

A specific example of step S101 executed by the query requirement acquisition unit 13 and the information element distribution requirement acquisition unit 11 will be described. As illustrated in FIG. 6, in step S101, a query requirement QR and an information element distribution requirement DR are acquired. The query requirement QR is a natural language sentence “I want to create questions regarding the question answer processing regarding sightseeing spots in Japan. Please provide ideas regarding the questions. It is desirable that there is a need to refer to a plurality of information elements for answers”. The query requirement QR includes a requirement “question answer processing” regarding the type of the natural language processing task, a requirement “sightseeing spots in Japan” regarding the content, and a requirement “refer to a plurality of information elements for answer” regarding execution of the natural language processing task.

The information element distribution requirement DR is a natural language sentence “Two information elements necessary for the answer to the question are described. Another unnecessary information element common to the topic of Japan is included. The necessary information elements are described twice in duplication. The information elements necessary for the answer to the question are described separately in two places. The length of the sentence to be generated is 1200 characters, and the unnecessary information elements occupy twice the length of the necessary information elements”. In the information element distribution requirement DR, the “information element necessary for the answer to the question” is an example of the information element related to the query. Hereinafter, the “information element necessary for the answer to the question” is also simply referred to as a “necessary information element”. The “unnecessary information element” is an “information element unnecessary for the answer to the question”, and is an example of an information element not related to a query.

The information element distribution requirement DR is decomposed into the following requirements REQ1 to REQ6. Decomposition into these requirements may be performed based on user input or may be performed using the language model M1.
(REQ1) Designation of the number of divisions of necessary information elements: Two information elements necessary for the answer to the question are described.
(REQ2) Number and content designation of unnecessary information elements: One other unnecessary information element having a common topic of Japan is included.
(REQ3) Designation of the number of times of duplication of necessary information elements: The necessary information elements are described twice in duplication.
(REQ4) Position designation of necessary information element: information elements: Information element necessary for the answer to the question are described separately in two places.
(REQ 5) Length designation of entire sentence: The length of the entire sentence is 1200 characters.
(REQ6) Length designation of each information element: The unnecessary information element occupies twice the length of the necessary information element.

For example, the requirements REQ1 to REQ4 are examples of requirements regarding the features of the order sequence of the information elements. The requirements REQ5 and REQ6 are examples of requirements regarding features unique to the information elements.

Check processing for the acquired information element distribution requirement DR may be performed. For example, a rule for evaluating the feasibility of the information element distribution requirement DR may be determined in advance. For example, a rule of “In a case where the information elements are divided into N places and the number of the information elements is designated as M, M≥N is satisfied” is determined in advance. In this case, the check processing is performed to determine whether the acquired information element distribution requirement DR satisfies the rule. In a case where the information element distribution requirement DR does not satisfy the rule, the sentence generation method S1A may end, or step S102 may be repeated until the information element distribution requirement DR that satisfies the rule is acquired. In a case where the generation of a sentence SS according to the information element distribution requirement DR has failed a predetermined number of times by the processing in and after step S102, it may be output that the information element distribution requirement DR cannot be implemented.

### Specific Example of Step S102

A specific example of step S102 executed by the query plan generation unit 14 will be described. In step S102, the above-described query requirement QR is input to the language model M1. An instruction sentence obtained by further adding an additional instruction such as “itemized form” to the query requirement QR may be input to the language model M1. As a result, output information “I understand. For example, how about the following question? *Question about sightseeing spots in each prefecture in Japan *Question about sightseeing spots in Japan by genre” is obtained from the language model M1. “*” is an example of a symbol indicating an itemized form. For example, the rule-based post-processing for extracting each item of the itemized form is performed on the output information, so that the query plan QP “Question about sightseeing spots in each prefecture in Japan” is generated. The rule base may be, for example, using a rule of a regular expression, but is not limited thereto.

### Specific Example of Step S103

A specific example of step S103 executed by the information element order sequence generation unit 121 will be described. In step S103, a plurality of information elements R1, R1′, IR1, R2, and R2′ are generated from the requirements REQ1 to REQ4 and the query plan regarding the features of the order sequence of the information elements. In addition, an order sequence L[R1, R1′, IR1, R2, R2′] of these information elements is generated. A specific example of step S103 includes steps S103-1 to S103-8.

In step S103-1, the information elements R1 and R2 necessary for the answer to the question are generated using the language model M1 based on the requirement REQ1 and the query plan QP. For example, first, the requirement REQ1 and the query plan QP are embedded in an instruction sentence generation template for generating an information element, so that an instruction sentence to be input to the language model M1 is generated. An example of the instruction sentence generation template for generating the information element will be described below.

### Example of Instruction Sentence Generation Template for Generating Information Element

“I think about creating the following question: {Query plan}. Output an example of contents of information elements necessary for answering this question in an itemized form into information elements {Number of information elements}. Consider {Contents of information elements}.”

For example, the query plan QP is embedded in {Query plan} in the above instruction sentence generation template. In the {Number of information elements}, “2” is embedded based on the requirement REQ1. As for the {Contents of information element}, since there is no particular designation in the requirement REQ1, nothing is embedded. As a result, for example, an instruction sentence “I think about creating the following question: A question about sightseeing spots in each prefecture in Japan. Output an example of contents of information elements necessary for answering this question in an itemized form into two information elements” is generated.

Next, in a case where the instruction sentence is input to the language model M1, output information “*Information element regarding sightseeing spots in Tokyo: Tokyo Tower and Senso-ji Temple. *Information element regarding sightseeing spots in Kyoto: Kinkakuji and Kiyomizu-dera Temple” is obtained from the language model M1.

Next, rule-based post-processing of extracting each item of the itemized form is performed on the output information, so that the information element R1 “Information regarding sightseeing spots in Tokyo: Tokyo Tower and Senso-ji Temple” and the information element R2 “Information regarding sightseeing spots in Kyoto: Kinkakuji and Kiyomizu-dera Temple” are generated. The information elements R1 and R2 are information elements necessary for the answer to the question.

In step S103-2, the check processing of determining whether the generated information elements R1 and R2 follow the information element distribution requirement DR and the query plan QP is performed. For example, the check processing may include a process of determining whether the check items CK1 to CK3 are satisfied, and in a case where any of the items is violated, step S103-1 may be executed again until all the check items are satisfied.
(CK1) Whether the divided information elements do not overlap and include information different from each other.
(CK2) Whether the generated information element is information regarding information required by the query plan QP (in this example, sightseeing spots of each prefecture in Japan).
(CK3) Whether the information elements are created for the quantity designated in the requirement REQ1.

The check processing may be executed using the language model M1. For example, an instruction sentence “Please decide whether the given information element satisfies the following rules based on the given information and answer YES or NO.” and information to be checked including an information element to be checked may be input to the language model M1. As a result, it is possible to determine whether the information element to be checked follows the rule depending on which of the character strings “YES” and “NO” is included in the output from the language model M1.

Here, for example, the information to be checked may be generated by embedding an information element to be checked in the generation template to be checked. An example of the check target generation template will be described below.

### Example of Check Target Generation Template

#Rule
{Item to be checked}
#Query Plan
{Query Plan}
#Information element distribution requirement
{Information element distribution requirement}
#Information element 1
{Information element 1}
#Information element 2
{Information element 2}

In the above-described check target generation template, a rule name is embedded in {Rule to be checked}. The query plan QP is embedded in {Query plan}. In the {Information element distribution requirement}, the requirement REQ1 to be checked in the information element distribution requirement DR is embedded. The generated first information element R1 is embedded in {Information Element 1}. The generated second information element R2 is embedded in {Information element 2}.

The check target generation template may be determined according to a rule to be checked. For example, for a rule unrelated to the query plan, another generation template to be checked that does not include “#Query plan {Query plan}” may be used. In the check target information template, an embedding place of “#Information element 1 {Information element 1}, #Information element 2 {Information element 2}, . . . ” may change according to the number of information elements to be checked. The check processing in step S103-2 may be omitted.

In step S103-3, the order sequence L[R1, R2] is generated by arranging the generated information elements R1 and R2 according to the requirement REQ1.

In step S103-4, the information element IR1 unnecessary for the answer to the question is generated using the language model M1 based on the requirement REQ2 and the query plan QP.

For example, first, information based on the requirement REQ2 and the query plan QP are embedded in an instruction sentence generation template for generating an information element, so that an instruction sentence to be input to the language model M1 is generated. An example of the instruction sentence generation template is as described in step S103-1, and thus detailed description will not be repeated. For example, the query plan QP is embedded in {Query plan} in the instruction sentence generation template. In the {Number of information elements}, “1” is embedded based on the requirement REQ2. In the {Contents of information element}, “unnecessary information element having common topic of Japan” is embedded based on the requirement REQ2. As a result, for example, an instruction sentence “I think about creating the following question: A question about sightseeing spots in each prefecture in Japan. Output an example of the contents of unnecessary information elements in an itemized form into one information element to answer this question. In this case, consider unnecessary information elements having a common topic of Japan,” is generated.

Next, the instruction sentence is input to the language model M1, so that output information “*Information about climate in Japan” is obtained from the language model M1.

Next, the output information is subjected to rule-based post-processing for extracting each item of the itemized form, thereby generating an information element IR1 “Information about climate in Japan”. The information element IR1 is an information element unnecessary for the answer to the question.

In step S103-5, the check processing of determining whether the generated information elements IR1 follow the information element distribution requirement DR and the query plan QP is performed. For example, the check processing may include a process of determining whether the check items CK4 to CK6 are satisfied, and in a case where any of the items is violated, step S103-4 may be executed again until all the check items are satisfied.
(CK4) Whether the number of unnecessary information elements is output by the number designated in the requirement REQ2.
(CK5) Whether only unnecessary information element is included in the query described in the query plan.
(CK6) Regarding unnecessary information element, is the content following the instruction in the requirement (commonality of topic such as Japan in this example)?

The check processing may be executed using the language model M1. A specific example of the check processing using the language model M1 will be described in substantially the same manner as in step S103-2, and thus detailed description will not be repeated. The check processing of step S103-5 may be omitted.

In step S103-6, the order sequence L is updated to [R1, R2, IR1] by adding the generated information element IR1 to the order sequence L according to the requirement REQ2.

In step S103-7, the information elements R1′ and R2′, which are duplicates of the information elements R1 and R2 necessary for the answer, are generated based on the number of times of duplication specified in the requirement REQ3. Here, the information element R1′ represents the same concept as the information element R1 and indicates an information element that appears at a position different from the position of the information element R1. In other words, duplicating an information element refers to generating a new information element having the same concept as the original information element and appearing at a different position. The partial sentences relevant to the information elements R1 and R1′ may be different from each other. The information element R2′ is similarly described. The order sequence L is updated to [R1, R2, IR1, R1′, R2′] by adding the duplicated information elements R1′ and R2′ to the order sequence L.

In step S103-8, the order sequence L is rearranged based on the requirement REQ4. Specifically, for example, the order sequence L is updated to [R1, R1′, IR1, R2, R2′] by performing sorting so that the information elements necessary for the answer to the question are separated in two places. This order sequence L satisfies the requirements REQ1 to REQ4 regarding the features of the order sequence of the information elements in the information element distribution requirement DR.

### Specific Example of Step S104

A specific example of step S104 executed by the sentence generation unit 12 will be described. In step S104, partial sentences PSS1 to PSS5 relevant to the information elements included in the order sequence L are generated so as to satisfy the requirements REQ5 and REQ6. These partial sentences are combined to generate a sentence SS. A specific example of step S104 includes steps S104-1 to S104-4.

In step S104-1, the length of the partial sentence relevant to each information element is calculated so as to satisfy the requirements REQ5 and REQ6. According to the requirement REQ6, the length of the partial sentence PSS3 relevant to the information element IR1 unnecessary for the answer to the question is twice the sum of the lengths of the partial sentences PSS1, PSS2, PSS4, and PSS5 relevant to the necessary information elements R1, R1′, R2, and R2′. According to the requirement REQ5, the length of the entire sentence SS to be generated is 1200 characters. Therefore, 800 characters are calculated as the length of the partial sentence PSS3, and 400 characters are calculated as the sum of the lengths of the partial sentences PSS1, PSS2, PSS4, and PSS5. 100 characters are calculated as the length of each of the partial sentences PSS1, PSS2, PSS4, and PSS5.

In step S104-2, based on the calculated lengths, the partial sentences PSS1 to PSS5 relevant to the information elements R1, R1′, IR1, R2, and R2′ are generated using the language model M1.

For example, first, by embedding each of the information elements R1, R1′, IR1, R2, and R2′ in an instruction sentence generation template for generating a partial sentence, an instruction sentence to be input to the language model M1 is generated. An example of the instruction sentence generation template for generating the partial sentence will be described below.

### Example of Instruction Sentence Generation Template for Generating Partial Sentence

Please write a sentence describing the following contents in {Number of characters} characters. Contents: {Contents of Information Element}

For example, in a case where an instruction sentence for generating the partial sentence PSS1 is generated, “100” calculated in step S104-1 is embedded in {Number of characters} in the above-described instruction sentence generation template. In the {Contents of information element}, an information element R1 “Information regarding sightseeing spots in Tokyo: Tokyo Tower and Senso-ji Temple” is embedded. As a result, for example, an instruction sentence “Please write 100 characters describing the following contents. Contents: information about sightseeing spots in Tokyo: Tokyo Tower and Senso-ji Temple” is generated. The instruction sentences for generating the partial sentences PSS2 to PSS5 are similarly generated.

Next, an instruction sentence for generating the partial sentence PSS1 is input to the language model M1, whereby the partial sentence PSS1 is generated. The partial sentences PSS2 to PSS5 are similarly generated.

In step S104-3, the check processing of determining whether the generated partial sentences PSS1 to PSS5 follow the information element distribution requirement DR and the query plan QP is performed. For example, the check processing may include a process of determining whether the check items CK7 to CK9 are satisfied, and in a case where any of the items is violated, steps S104-1 to S104-2 may be executed again until all the check items are satisfied.
(CK7) Whether the length of the generated partial sentence is within the allowable range (for example, within plus or minus 10%) as compared with the specified length.
(CK8) Whether the generated partial sentence includes information about the relevant information element.
(CK9) Whether the generated partial sentence includes information about another information element other than the relevant information element.

The check processing based on the check items CK8 and CK9 may be executed using the language model M1. A specific example of the check processing using the language model M1 will be described in substantially the same manner as in step S103-2, and thus detailed description will not be repeated. The check processing of step S104-3 may be omitted.

In step S104-4, the generated partial sentences PSS1 to PSS5 are combined according to the order sequence L, so that the sentence SS is generated.

### Specific Example of Step S105

A specific example of step S105 executed by the query generation unit 15 will be described. The query Q is generated using the language model M1 based on the sentence SS and the query plan QP. For example, by embedding the sentence SS and the query plan QP in an instruction sentence generation template for generating a query, an instruction sentence to be input to the language model M1 is generated. An example of the instruction sentence generation template for generating the query will be described below.

### Example of Instruction Sentence Generation Template for Generating Query

Please read the following sentence:
{Sentence}

Given this sentence, create a specific query with the following content:
{Query Plan}

For example, the sentence SS is embedded in {Sentence} in the above-described instruction sentence generation template. The query plan QP is embedded in {Query plan}.

Next, the instruction sentence is input to the language model M1, thereby generating the query Q “Please read the sentences provided and answer the information on sightseeing spots in Japan for each prefecture”.

The sentence SS and the query Q generated in this manner are output from the output unit 140 to be presented to the user. As a result, the user can obtain the query Q and the sentence SS that satisfy the desired query requirement QR and information element distribution requirement DR. The information (for example, the query plan QP, the order sequence L, the contents of the information elements R1, R1′, IR1, R2, and R2′, the partial sentences PSS1 to PSS5, and the like) obtained in the process of generating the query Q and the sentence SS may be further output to the output unit 140 to be presented to the user.

### Effects of Sentence Generation Device 1a

As described above, in the sentence generation device 1A, the sentence generation unit 12 generates an information element so as to satisfy the information element distribution requirement, and generates a sentence using the generated information element. Therefore, according to the sentence generation device 1A, in addition to the effect obtained by the sentence generation device 1, it is possible to obtain an effect that the sentence can be generated so as to more reliably satisfy the information element distribution requirement. In a case where an information element is generated first, a partial sentence relevant to the generated information element is generated, and a sentence composed of the partial sentence is generated, a more natural sentence can be generated.

In the sentence generation device 1A, a configuration is adopted in which the information element distribution requirement includes a requirement regarding a feature of an order sequence of information elements and a requirement regarding a feature unique to the information elements, and the sentence generation unit 12 generates the order sequence of the plurality of information elements based on the requirement regarding the feature as the order sequence of the information elements, and generates the sentence based on the order sequence and the requirement regarding the feature unique to each information element. Therefore, according to the sentence generation device 1A, in addition to the effect obtained by the sentence generation device 1, it is possible to obtain an effect of generating a sentence satisfying a desired feature as a feature unique to an information element and a feature of an order sequence of the information element.

The sentence generation device 1A further includes a query requirement acquisition unit 13 that acquires a query requirement regarding a query indicating a natural language processing task to be performed on the sentence, and the sentence generation unit 12 generates the sentence satisfying the information element distribution requirement by further referring to the query requirement. Therefore, according to the sentence generation device 1A, in addition to the effect obtained by the sentence generation device 1, it is possible to generate a sentence satisfying a desired information element distribution requirement as a sentence for which a natural language processing task is to be executed by a query satisfying a desired query requirement.

The sentence generation device 1A further includes a query generation unit 15 that generates a query with reference to the sentence generated by the sentence generation unit 12 and the query requirement. Therefore, according to the sentence generation device 1A, in addition to the effect obtained by the sentence generation device 1, it is possible to generate a query, as the query satisfying the desired query requirement, more suitable for the sentence for which the natural language processing task is to be executed by the query.

The sentence generation device 1A adopts a configuration in which the information element distribution requirement includes a requirement regarding an information element related to a query or a requirement regarding an information element not related to a query. Therefore, according to the sentence generation device 1A, in addition to the effect obtained by the sentence generation device 1, it is possible to generate a sentence in which an information element related to a query or an information element not related to a query satisfies a desired information element distribution requirement.

### Third Illustrative Example Embodiment

A third illustrative example embodiment, which is an example of an example embodiment, will be described in detail with reference to the drawings. Constituents having the same functions as the constituents described in the above-described illustrative example embodiment are denoted by the same reference sign, and the description thereof will be omitted as appropriate. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be employed in the other illustrative example embodiments included in the present disclosure within the scope in which no particular technical problem occurs.

### Outline of Sentence Generation System 100B

A sentence generation system 100B is a modification of the sentence generation system 100A. The sentence generation system 100B evaluates the language model to be evaluated using the query and the sentence generated similarly to the sentence generation system 100A.

### Configuration of Sentence Generation System 100B

A configuration of the sentence generation system 100B will be described with reference to FIG. 7. FIG. 7 is a block diagram illustrating a configuration of the sentence generation system 100B. The sentence generation system 100B includes a sentence generation device 1B, a language model storage device 2, and an evaluation target storage device 3. The sentence generation device 1B is communicably connected to each of the language model storage device 2 and the evaluation target storage device 3 via a network NW. Since the language model storage device 2 and the network NW are as described above, the detailed description will not be repeated.

### Evaluation Target Storage Device 3

The evaluation target storage device 3 stores a language model M2. The language model M2 is a model that executes a natural language processing task relevant to a query on a sentence. Examples of the language model M2 include, but are not limited to, models called LLaAM and other large language models. The language model M2 is a target for evaluating the performance of the language processing task. The target language model evaluated by the sentence generation device 1B is not limited to one, and may be a plurality of language models. For example, another evaluation target language model different from the language model M2 may be further stored in the evaluation target storage device 3. Another evaluation target storage device that stores a language model of another evaluation target type may be communicably connected to the sentence generation device 1B.

### Sentence Generation Device 1b

The sentence generation device 1B includes an evaluation unit 16 in the control unit 110 in addition to the same configuration as the sentence generation device 1A. The evaluation unit 16 is an example of a configuration that implements an evaluation means. The information element distribution requirement acquisition unit 11 is configured as follows in addition to being configured similarly to the information element distribution requirement acquisition unit 11 in the sentence generation device 1A. Other configurations are similar to those of the sentence generation device 1A, and thus detailed description will not be repeated.

The information element distribution requirement acquisition unit 11 acquires the information element distribution requirement by generating the information element distribution requirement based on the query requirement. For example, the information element distribution requirement acquisition unit 11 may generate the query requirement by embedding information based on the query requirement in the information element distribution requirement generation template. An example of the information element distribution requirement generation template will be described below.

### Example of Information Element Distribution Requirement Generation Template

{Numerical value 1} information elements necessary for {Natural language processing task} are described. {Numerical value 2} other unnecessary information elements having a common topic of {Topic} are included. Information elements necessary for {Natural language processing task} are described separately in {Numerical value 3} places. The length of the sentence to be generated is {Numerical value 4} characters, and unnecessary information occupies {Numerical value 5} times the length of necessary information.

In the information element distribution requirement generation template, information extracted from the query requirement is embedded in {Natural language processing task} and {Topic}. Any numerical value within a predetermined range is embedded in each of {Numerical value 1} to {Numerical value 5}.

The information element distribution requirement acquisition unit 11 may generate a plurality of different information element distribution requirements based on the same query requirement. Hereinafter, an example of a plurality of different information element distribution requirements will be also referred to as a first information element distribution requirement and a second information element distribution requirement.

For example, the information element distribution requirement acquisition unit 11 may generate the first information element distribution requirement and the second information element distribution requirement by making at least some of numerical values to be embedded different from each other using the same query requirement and the same information element distribution requirement generation template.

As an example, an example of generating the first information element distribution requirement and the second information element distribution requirement by making at least some of {Numerical value 1} to {Numerical value 5} different using the same query requirement QR illustrated in FIG. 7 and the same information element distribution requirement generation template described above will be described.

First, the first information element distribution requirement is generated as follows. The “question answering” is extracted as the natural language processing task from the query requirement QR and embedded in the {Natural language processing task} of the information element distribution requirement generation template. “Japan” is extracted as a topic from the query requirement QR and is embedded in {Topic}. 2, 1, 2, 1200, and 2 are embedded in {Numerical value 1}, {Numerical value 2}, {Numerical value 3}, {Numerical value 4}, and {Numerical value 5}. As a result, “Two information elements necessary for the answer to the question are described. Another unnecessary information element having a common topic of Japan is included. The information elements necessary for the answer to the question are described separately in two places. The length of the sentence to be generated is 1200 characters, and the unnecessary information occupy twice the length of the necessary information.” is generated as the first information element distribution requirement.

The second information element distribution requirement is generated as follows. The “question answering” is embedded in {Natural language processing task} similarly to the first information element distribution requirement. 2, 1200, and 2 are embedded in {Numerical value 1}, {Numerical value 4}, and {Numerical value 5}, similarly to the first information element distribution requirement, and 0 and 1 different from the first information element distribution requirement are embedded in {Numerical value 2} and {Numerical value 3}. In a case where 0 is embedded in {Numerical value 2}, as an example, it may be defined that the sentence itself including {Numerical value 2} is deleted. In this case, embedding in {Topic} becomes unnecessary accordingly. In a case where 1 is embedded in {Numerical value 3}, as an example, it may be defined that “separately in places” with {Numerical value 3} is changed to “collectively in one place”. As a result, “Two information elements necessary for the answer to the question are described. Information elements necessary for the answer to the question are described collectively in one place. The length of the sentence to be generated is 1200 characters, and the unnecessary information occupy twice the length of the necessary information.” is generated as the second information element distribution requirement.

The method of generating the first information element distribution requirement and the second information element distribution requirement is not limited to the example described above. For example, the information element distribution requirement acquisition unit 11 may generate the first information element distribution requirement and the second information element distribution requirement using a plurality of different information element distribution requirement generation templates based on the same query requirement. For example, the information element distribution requirement acquisition unit 11 may generate the first information element distribution requirement and the second information element distribution requirement by applying the same information element distribution requirement generation template to each of the first query requirement and the second query requirement different from each other.

The evaluation unit 16 evaluates the language model M2 to be evaluated using a plurality of sentences generated by the sentence generation unit 12 based on a plurality of information element distribution requirements different from each other. For example, as the plurality of information element distribution requirements different from each other, the above-described first information element distribution requirement and second information element distribution requirement generated by the information element distribution requirement acquisition unit 11 may be used, or the first information element distribution requirement and the second information element distribution requirement input by the user may be used. As the plurality of sentences, a first sentence generated by the sentence generation unit 12 based on the query plan and the first information element distribution requirement and a second sentence generated by the sentence generation unit 12 based on the query plan and the second information element distribution requirement may be used. As a result, knowledge regarding the influence on the performance of the language model M2 due to the difference in the information element distribution in the sentence to be processed is obtained.

### Flow of Evaluation Method S1b

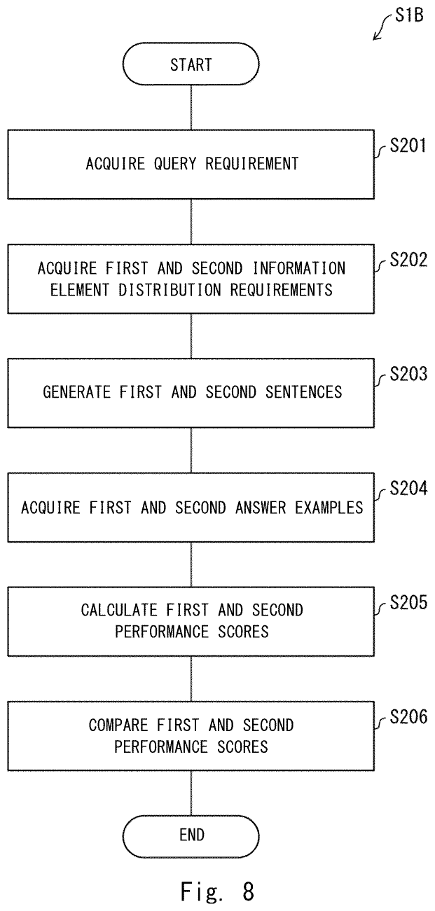

FIG. 8 is a flowchart illustrating a flow of an evaluation method S1B by the sentence generation device 1B. As illustrated in FIG. 8, the evaluation method S1B includes steps S201 to S206.

In step S201, the query requirement acquisition unit 13 acquires the query requirement.

In step S202, the information element distribution requirement acquisition unit 11 acquires the first information element distribution requirement and the second information element distribution requirement. For example, the information element distribution requirement acquisition unit 11 may acquire the first information element distribution requirement and the second information element distribution requirement input by the user, or may generate the first information element distribution requirement and the second information element distribution requirement based on the query requirement acquired in step S201.

In step S203, the sentence generation device 1B generates the first query and the first sentence based on the query requirement and the first information element distribution requirement. The first query is a query generated based on the query plan based on the query requirement and the first sentence. The sentence generation device 1B generates the second query and the second sentence based on the query requirement and the second information element distribution requirement. The second query is a query generated based on the query plan based on the query requirement and the second sentence. Details of step S203 are similar to those of the sentence generation method S1A, and thus detailed description will not be repeated. The first query may be used as the second query instead of generating the second query in order to clarify the influence of the difference in the information element distribution requirement in the comparison of the performance scores described later.

In step S204, the evaluation unit 16 acquires a first answer example and a second answer example. The first answer example is an answer example serving as a reference in a case where the first query is executed on the first sentence. The first answer example may be input by the user, or may be generated by inputting the first query and the first sentence to a reference language model (not illustrated). The reference language model is a language model different from the language model M2 to be evaluated. The second answer example will be similarly described by replacing the first with the second in the description of the first answer example.

In step S205, the evaluation unit 16 calculates a first performance score and a second performance score. The first performance score indicates performance in a case where the natural language processing task indicated by the first query is executed on the first sentence by the language model M2. For example, the evaluation unit 16 obtains a first answer output by inputting the first query and the first sentence to the language model M2. The evaluation unit 16 calculates the first performance score based on the degree of coincidence between the obtained first answer and the first answer example. The second performance score is similarly described by replacing the first with the second in the description of the first performance score.

In step S206, the evaluation unit 16 outputs a comparison result between the first performance score and the second performance score. The comparison result may be, for example, an image (for example, a table, a graph, an itemized form, or the like) including the first performance score associated with the first information element distribution requirement and the second performance score associated with the second information element distribution requirement. As a result, the user can know the influence of the difference in the information element distribution in the sentence to be processed on the performance of the language model M2.

### Effects of Sentence Generation Device 1b

As described above, the sentence generation device 1B adopts a configuration in which the information element distribution requirement acquisition unit 11 acquires the information element distribution requirement by generating the information element distribution requirement based on the query requirement. Therefore, according to the sentence generation device 1B, in addition to the effect obtained by the sentence generation device 1, it is possible to obtain an effect that the information element distribution requirement can be acquired without depending on the user's input. In a case where a plurality of information element distribution requirements different from each other are required to evaluate the language model to be evaluated, it is possible to more easily acquire the plurality of information element distribution requirements.

The sentence generation device 1B employs a configuration further including an evaluation unit 16 that evaluates the language model M2 to be evaluated using a plurality of sentences generated by the sentence generation unit 12 based on a plurality of information element distribution requirements different from each other. Therefore, according to the sentence generation device 1B, in addition to the effects obtained by the sentence generation device 1, it is possible to evaluate the influence of the different information element distribution on the performance of the language model M2.

### Implementation Example by Software

Some or all of the functions of the sentence generation devices 1, 1A, and 1B (referred to below also as “each of the devices above”) may be implemented by hardware such as an integrated circuit (IC chip) or may be implemented by software.

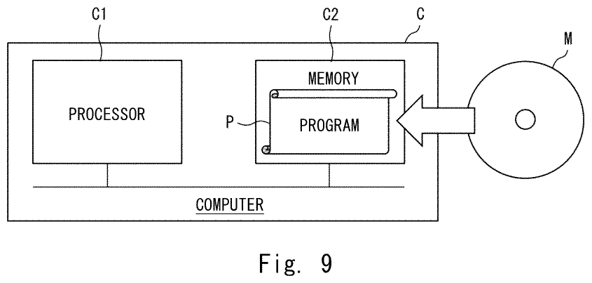

In the latter case, each of the above devices is achieved by, for example, a computer that executes a command of a program as software for achieving each function. FIG. 9 illustrates an example of such a computer (hereinafter, referred to as a computer C). FIG. 9 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for exchanging data with another device. The computer C may further include an input/output interface for connecting input/output equipment such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by a single processor provided in a single computer, may be implemented in cooperation by a plurality of processors provided in a single computer, or may be implemented in cooperation by a plurality of processors provided in a plurality of computers. The program for causing each of the above apparatuses to implement each of the above functions may be stored in a single memory provided in a single computer, may be stored in a distributed manner in a plurality of memories provided in a single computer, or may be stored in a distributed manner in a plurality of memories provided in each of a plurality of computers.

### SUPPLEMENTARY INFORMATION A

The whole or part of the example embodiments disclosed above can be described as, but not limited to, the following supplementary notes.

### Supplementary Note A1

A sentence generation device that generates a sentence composed of a natural language sentence, the sentence generation device including:
an information element distribution requirement acquisition means for acquiring an information element distribution requirement regarding a distribution of the information elements to be included in the sentence; and
a sentence generation means for generating the sentence so as to satisfy the information element distribution requirement using a language model.

### Supplementary Note A2

The sentence generation device according to Supplementary Note A1, in which the sentence generation means generates the information element so as to satisfy the information element distribution requirement, and generates the sentence using the generated information element.

### Supplementary Note A3

The sentence generation device according to Supplementary Note A1 or A2, in which
the information element distribution requirement includes a requirement regarding a feature of an order sequence of the information elements and a requirement regarding a feature unique to the information elements, and
the sentence generation means generates an order sequence of a plurality of the information elements based on a requirement regarding a feature as an order sequence of the information elements, and generates the sentence based on the order sequence and a requirement regarding a feature unique to each information element.

### Supplementary Note A4

The sentence generation device according to any one of Supplementary Note A1 to A3, further including a query requirement acquisition means for acquiring a query requirement regarding a query indicating a natural language processing task to be executed on the sentence,
in which the sentence generation means generates the sentence satisfying the information element distribution requirement with further reference to the query requirement.

### Supplementary Note A5

The sentence generation device according to Supplementary Note A4, further including a query generation means for generating the query with reference to the sentence generated by the sentence generation means and the query requirement.

### Supplementary Note A6

The sentence generation device according to Supplementary Note A4 or A5, in which the information element distribution requirement includes a requirement regarding an information element related to the query or a requirement regarding an information element not related to the query.

### Supplementary Note A7

The sentence generation device according to any one of Supplementary Notes A4 to A6, in which the information element distribution requirement acquisition means acquires the information element distribution requirement by generating the information element distribution requirement based on the query requirement.

### Supplementary Note A8

The sentence generation device according to any one of Supplementary Notes A1 to A7, further including an evaluation means for evaluating an evaluation target language model using a plurality of sentences generated by the sentence generation means based on a plurality of the information element distribution requirements different from each other.

### SUPPLEMENTARY INFORMATION B

The whole or part of the example embodiments disclosed above can be described as, but not limited to, the following supplementary notes.

### Supplementary Note B1

A sentence generation method in which a sentence composed of a natural language sentence is generated, the method including:
information element distribution requirement acquisition processing of acquiring, by at least one processor, an information element distribution requirement regarding a distribution of information elements to be included in the sentence; and
sentence generation processing of generating, by the at least one processor, the sentence so as to satisfy the information element distribution requirement using a language model.

### Supplementary Note B2

The sentence generation method according to Supplementary Note B1, in which in the sentence generation processing the at least one processor generates the information element so as to satisfy the information element distribution requirement, and generates the sentence using the generated information element.

### Supplementary Note B3

The sentence generation method according to Supplementary Note B1 or B2, in which
the information element distribution requirement includes a requirement regarding a feature of an order sequence of the information elements and a requirement regarding a feature unique to the information elements, and
in the sentence generation processing, the at least one processor generates an order sequence of a plurality of the information elements based on a requirement regarding a feature as an order sequence of the information elements, and generates the sentence based on the order sequence and a requirement regarding a feature unique to each information element.

### Supplementary Note B4

The sentence generation method according to any one of Supplementary Notes B1 to B3, in which
the at least one processor further includes query requirement acquisition processing of acquiring a query requirement regarding a query indicating a natural language processing task to be performed on the sentence, and
in the sentence generation processing, the at least one processor generates the sentence satisfying the information element distribution requirement by further referring to the query requirement.

### Supplementary Note B5

The sentence generation method according to Supplementary Note B4, in which the at least one processor further includes query generation processing of generating the query with reference to the sentence generated by the sentence generation processing and the query requirement.

### Supplementary Note B6

The sentence generation method according to Supplementary Note B4 or B5, in which the information element distribution requirement includes a requirement regarding an information element related to the query or a requirement regarding an information element not related to the query.

### Supplementary Note B7

The sentence generation method according to any one of Supplementary Notes B4 to B6, in which in the information element distribution requirement acquisition processing, the at least one processor acquires the information element distribution requirement by generating the information element distribution requirement based on the query requirement.

### Supplementary Note B8

The sentence generation method according to any one of Supplementary Notes B1 to B7, further including evaluation processing of evaluating, by the at least one processor, an evaluation target language model using a plurality of sentences generated by the sentence generation processing based on a plurality of the information element distribution requirements different from each other.

### SUPPLEMENTARY INFORMATION C

The whole or part of the example embodiments disclosed above can be described as, but not limited to, the following supplementary notes.

### Supplementary Note C1

A non-transitory computer readable medium having stored therein a sentence generation program for causing a computer to function as a sentence generation device that generates a sentence composed of a natural language sentence, the program for causing the computer to function as:
an information element distribution requirement acquisition means for acquiring an information element distribution requirement regarding a distribution of information elements to be included in the sentence; and
a sentence generation means for generating the sentence so as to satisfy the information element distribution requirement using a language model.

### Supplementary Note C2

The non-transitory computer readable medium having stored therein the sentence generation program according to Supplementary Note C1, in which the sentence generation means generates the information element so as to satisfy the information element distribution requirement, and generates the sentence using the generated information element.

### Supplementary Note C3

The non-transitory computer readable medium having stored therein the sentence generation program according to Supplementary Note C1 or C2, in which
the information element distribution requirement includes a requirement regarding a feature of an order sequence of the information elements and a requirement regarding a feature unique to the information elements, and
the sentence generation means generates an order sequence of a plurality of the information elements based on a requirement regarding a feature as an order sequence of the information elements, and generates the sentence based on the order sequence and a requirement regarding a feature unique to each information element.

### Supplementary Note C4

The non-transitory computer readable medium having stored therein the sentence generation program according to any one of Supplementary Notes C1 to C3, in which
the computer is caused to further function as a query requirement acquisition means for acquiring the query requirement regarding a query indicating a natural language processing task to be executed on the sentence, and
the sentence generation means generates the sentence satisfying the information element distribution requirement with further reference to the query requirement.

### Supplementary Note C5

The non-transitory computer readable medium having stored therein the sentence generation program according to Supplementary Note C4, in which the computer is caused to further function as a query generation means for generating the query with reference to the sentence generated by the sentence generation means and the query requirement.

### Supplementary Note C6

The non-transitory computer readable medium having stored therein the sentence generation program according to Supplementary Note C4 or C5, in which the information element distribution requirement includes a requirement regarding an information element related to the query or a requirement regarding an information element not related to the query.

### Supplementary Note C7

The non-transitory computer readable medium having stored therein the sentence generation program according to any one of Supplementary Note C4 to C6, in which the information element distribution requirement acquisition means acquires the information element distribution requirement by generating the information element distribution requirement based on the query requirement.

### Supplementary Note C8

The non-transitory computer readable medium having stored therein the sentence generation program according to any one of Supplementary Note C1 to C7, in which the computer is caused to further function as an evaluation means for evaluating a language model to be evaluated using a plurality of sentences generated by the sentence generation means based on a plurality of the information element distribution requirements different from each other.

### SUPPLEMENTARY INFORMATION D

The whole or part of the example embodiments disclosed above can be described as, but not limited to, the following supplementary notes.

### Supplementary Note D1

A sentence generation device that generates a sentence composed of a natural language sentence, the sentence generation device including at least one processor, in which the at least one processor executes:
information element distribution requirement acquisition processing of acquiring an
information element distribution requirement regarding a distribution of information elements to be included in the sentence; and
sentence generation processing of generating the sentence so as to satisfy the information element distribution requirement using a language model.

The sentence generation device may further include a memory. The memory may store a program for causing the at least one processor to execute each processing.

### Supplementary Note D2

The sentence generation device according to Supplementary Note D1, in which in the sentence generation processing the at least one processor generates the information element so as to satisfy the information element distribution requirement, and generates the sentence using the generated information element.

### Supplementary Note D3

The sentence generation device according to Supplementary Note D1 or D2, in which
the information element distribution requirement includes a requirement regarding a feature of an order sequence of the information elements and a requirement regarding a feature unique to the information elements, and
in the sentence generation processing, the at least one processor generates an order sequence of a plurality of the information elements based on a requirement regarding a feature as an order sequence of the information elements, and generates the sentence based on the order sequence and a requirement regarding a feature unique to each information element.

### Supplementary Note D4

The sentence generation device according to any one of Supplementary Notes D1 to D3, in which
the at least one processor further executes query requirement acquisition processing of acquiring a query requirement regarding a query indicating a natural language processing task to be performed on the sentence, and
in the sentence generation processing, the at least one processor generates the sentence satisfying the information element distribution requirement by further referring to the query requirement.

### Supplementary Note D5

The sentence generation device according to Supplementary Note D4, in which the at least one processor further executes query generation processing of generating the query with reference to the sentence generated by the sentence generation processing and the query requirement.

### Supplementary Note D6

The sentence generation device according to Supplementary Note D4 or D5, in which the information element distribution requirement includes a requirement regarding an information element related to the query or a requirement regarding an information element not related to the query.

### Supplementary Note D7

The sentence generation device according to any one of Supplementary Notes D4 to D6, in which in the information element distribution requirement acquisition processing, the at least one processor acquires the information element distribution requirement by generating the information element distribution requirement based on the query requirement.

### Supplementary Note D8

The sentence generation device according to any one of Supplementary Notes D1 to D7, in which the at least one processor further executes evaluation processing of evaluating an evaluation target language model using a plurality of sentences generated by the sentence generation processing based on a plurality of the information element distribution requirements different from each other.

### SUPPLEMENTARY INFORMATION E

The whole or part of the example embodiments disclosed above can be described as, but not limited to, the following supplementary notes.

### Supplementary Note E1

A non-transitory recording medium having recorded therein a sentence generation program for causing a computer as a sentence generation device that generates a sentence composed of a natural language sentence,
in which the program causes the computer to execute:
information element distribution requirement acquisition processing of acquiring an information element distribution requirement regarding a distribution of information elements to be included in the sentence; and
sentence generation processing of generating the sentence so as to satisfy the information element distribution requirement using a language model.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A sentence generation device that generates a sentence composed of a natural language sentence, the sentence generation device comprising:
at least one memory storing instructions; and
at least one processor configured to execute the instructions to:
acquire an information element distribution requirement regarding a distribution of information elements to be included in the sentence; and
generate the sentence using a language model so as to satisfy the information element distribution requirement.

2. The sentence generation device according to claim 1, wherein the processor is configured to execute the instructions to generate the information elements to satisfy the information element distribution requirement, and generate the sentence using the generated information elements.

3. The sentence generation device according to claim 1, wherein
the information element distribution requirement includes a requirement regarding a feature of an order sequence of the information elements and a requirement regarding a feature unique to the information elements, and
the processor is configured to execute the instructions to generate an order sequence of a plurality of the information elements based on a requirement regarding a feature as an order sequence of the information elements, and generate the sentence based on the order sequence and a requirement regarding a feature unique to each information element.

4. The sentence generation device according to claim 1,
wherein the processor is configured to execute the instructions to:
acquire a query requirement for a query indicating a natural language processing task to be performed on the sentence; and
generate the sentence satisfying the information element distribution requirement with further reference to the query requirement.

5. The sentence generation device according to claim 4, wherein the processor is configured to execute the instructions to generate the query with reference to the generated sentence and the query requirement.

6. The sentence generation device according to claim 4, wherein the information element distribution requirement includes a requirement regarding an information element related to the query or a requirement regarding an information element not related to the query.

7. The sentence generation device according to claim 4, wherein the processor is configured to execute the instructions to acquire the information element distribution requirement by generating the information element distribution requirement based on the query requirement.

8. The sentence generation device according to claim 1, wherein the processor is configured to execute the instructions to evaluate a language model to be evaluated by using a plurality of sentences generated based on a plurality of the information element distribution requirements different from each other.

9. A sentence generation method in which at least one processor generates a sentence composed of a natural language sentence, the method comprising:
information element distribution requirement acquisition processing of acquiring, by the at least one processor, an information element distribution requirement regarding a distribution of information elements to be included in the sentence; and
sentence generation processing of generating, by the at least one processor, the sentence so as to satisfy the information element distribution requirement using a language model.

10. The sentence generation method according to claim 9, wherein in the sentence generation processing, the at least one processor generates the information element so as to satisfy the information element distribution requirement, and generates the sentence using the generated information element.

11. The sentence generation method according to claim 9, wherein
the information element distribution requirement includes a requirement regarding a feature of an order sequence of the information elements and a requirement regarding a feature unique to the information elements, and
in the sentence generation processing, the at least one processor generates an order sequence of a plurality of the information elements based on a requirement regarding a feature as an order sequence of the information elements, and generates the sentence based on the order sequence and a requirement regarding a feature unique to each information element.

12. The sentence generation method according to claim 9, wherein
the method further comprises query requirement acquisition processing of acquiring, by the at least one processor, a query requirement regarding a query indicating a natural language processing task to be performed on the sentence, and
in the sentence generation processing, the at least one processor generates the sentence satisfying the information element distribution requirement by further referring to the query requirement.

13. The sentence generation method according to claim 12, wherein the method further comprises query generation processing of generating, by the at least one processor, the query with reference to the sentence generated by the sentence generation processing and the query requirement.

14. The sentence generation method according to claim 12, wherein the information element distribution requirement includes a requirement regarding an information element related to the query or a requirement regarding an information element not related to the query.

15. The sentence generation method according to claim 12, wherein in the information element distribution requirement acquisition processing, the at least one processor acquires the information element distribution requirement by generating the information element distribution requirement based on the query requirement.

16. The sentence generation method according to claim 9, further comprising evaluation processing of evaluating, by the at least one processor, a language model to be evaluated by using a plurality of sentences generated by the sentence generation processing based on a plurality of the information element distribution requirements different from each other.

17. A non-transitory computer readable medium having stored therein a sentence generation program for causing a computer to function as a sentence generation device that generates a sentence composed of a natural language sentence, the program for causing the computer to execute:
information element distribution requirement acquisition processing of acquiring an information element distribution requirement regarding a distribution of information elements to be included in the sentence; and
sentence generation processing of generating the sentence so as to satisfy the information element distribution requirement using a language model.

18. The non-transitory computer readable medium having stored therein the sentence generation program according to claim 17, wherein in the sentence generation processing, the information element is generated so as to satisfy the information element distribution requirement, and the sentence is generated using the generated information element.

19. The non-transitory computer readable medium having stored therein the sentence generation program according to claim 17, wherein
the information element distribution requirement includes a requirement regarding a feature of an order sequence of the information elements and a requirement regarding a feature unique to the information elements, and
in the sentence generation processing, an order sequence of a plurality of the information elements is generated based on a requirement regarding a feature as an order sequence of the information elements, and the sentence is generated based on the order sequence and a requirement regarding a feature unique to each information element.

20. The non-transitory computer readable medium having stored therein the sentence generation program according to claim 17, wherein
the computer is caused to execute query requirement acquisition processing of acquiring a query requirement regarding a query indicating a natural language processing task to be performed on the sentence, and
in the sentence generation processing, the sentence satisfying the information element distribution requirement is generated with further reference to the query requirement.
